(19) United States
(12) Patent Application Publication
(10) Pub. No.: US 2003/0031618 A1
(43) Pub. Date: Feb. 13, 2003

(54) Process for eliminating oxygen from a gas that contains carbon dioxide

(75) Inventor: Ari Minkkinen, Saint Nom La Breteche (FR)

Correspondence Address: MILLEN, WHITE, ZELANO & BRANIGAN, P.C., 2200 CLARENDON BLVD., SUITE 1400, ARLINGTON, VA, 22201, US

(73) Assignee: Institut Francais du Petrole, Rueil Malmaison Cedex (FR)

(21) Appl. No.: 10/121,853

(22) Filed: Apr. 15, 2002

(30) Foreign Application Priority Data
Apr. 13, 2001 (FR) 01/05.155

(51) Int. Cl. C01B 31/20

(52) U.S. Cl. 423/437.1; 423/219

(57) ABSTRACT

A process for eliminating oxygen (O₂) from a gas that contains nitrogen and carbon dioxide (CO₂) is described in which combustion of the gas with a hydrocarbon stream is carried out in at least one catalytic combustion zone (5); at the end of the combustion zone, combustion effluents (line 9) that essentially no longer contain O₂, a major portion of CO₂, and water, are recovered; said combustion effluents are cooled in at least one heat-exchange zone (10) (4) (11) (12); and the cooled effluents are condensed in at least one condensation zone (13) from where condensed water (line 14) and a gas effluent (line 15) essentially no longer containing oxygen are extracted.

Application for the re-injection of CO₂ that is purified in a process for assisted recovery of petroleum.

The invention relates to a process for purifying a gas that contains carbon dioxide (CO₂) and a minor portion of oxygen (O₂) that contaminates it.

Patents GB-A-2 327 371, WO-A-00 11313 and DE-A-196 01 713 illustrate the technological background.

Patent FR-A-2 217 21 teaches a process for obtaining a nitrogen-type cover gas from air. The effluent that is obtained, however, also contains 2 to 5% oxygen. This patent does not describe and does not suggest a process for essentially total elimination of oxygen from a carbon dioxide stream that contains a minor portion of oxygen.

The invention returns to the problem of the sequestration of CO₂ to reduce the greenhouse effect that becomes a major concern for the environment. It is actually admitted by the entire community that the CO₂ content in the atmosphere rose from 280 ppm to 360 ppm in the 20th century and that with the current rate of releases of industrial fumes and exhaust gas, values of between 550 and 970 ppm should be reached from now until 2100 for the most pessimistic forecasts. This increase of CO₂ should produce a global warming of the planet that, according to the models, is evaluated between 1.5° C. and 6° C. for the century to come. The consequences of this warming are still more difficult to foresee, but the scientific community and the industrial world are increasingly aware of the importance of limiting CO₂ releases in the years to come.

Among the gases that contain a majority of CO₂ are found the gases that are obtained from industrial combustion, fumes from furnaces of any industrial category and boilers of thermal electric stations. It is also possible to cite the fumes that are obtained from gas turbines that are used in particular in co-generation. The total amount of CO₂ released into the atmosphere by all of the emission sources, industrial fumes and exhaust gas is evaluated at 22 billion tons. Now, these different fumes generally also contain significant amounts of oxygen; it is possible to cite the following values for the different types of fuels:

0.3% for gaseous and liquid fuels

0.6% for solid fuels

0.11% for waste-type fuels such as wastes that are obtained from household garbage.

In general, the more heterogeneous a fuel is, the more excess air that it will be necessary to use during the combustion and the more fumes that result from this combustion will have a high oxygen content. In the case of gas turbines that work with very large excesses of air, in general oxygen content values in the exhaust gases of 12 to 17% are retained.

One of the methods considered for taking advantage of CO₂ and at the same time sequestering it is to use it in the assisted recovery of petroleum. With the pressures of wells on the order of one hundred bar (1 bar 10⁵ Pa), the CO₂ dissolves in the liquid phase of the petroleum layer and reduces its viscosity, making its extraction easier and making it possible to obtain, based on the type of crude oils, recovery rates of 30 to 45%. A portion of re-injected CO₂ is thus sequestered in the reservoir.

This use of CO₂, however, requires that the oxygen that the latter contains be removed in advance.

The object of the invention is therefore the purification of a gas that contains CO₂ of the small amounts of oxygen that it contains so as to make subsequent use of this gas in assisted recovery of petroleum completely certain.

Another object of the invention is the elimination of oxygen before a process for CO₂ solvent extraction is used.

Finally, a last object of the invention is to carry out a sequestering of CO₂ that contributes to the reduction of the greenhouse effect.

The invention relates to a process for treatment of a gas that is loaded with N₂, CO₂, and H₂O and that contains a minor portion of O₂, whereby this gas is generally obtained from an industrial combustion process but can also be obtained from gas turbines. The gas, which for the sake of simplicity we will refer to below as gas that is loaded with C₂, undergoes a treatment that is intended to eliminate the minor portion of O₂ that it contains before being re-injected into an underground petroleum well within the framework of a process for assisted recovery of petroleum as described in patent application Ser. No. 00/05,425 of Apr. 27, 2000. The recovery of the minor portion of O₂ that is contained in the gas that is loaded with CO₂ is carried out via a combustion stage of a certain amount of hydrocarbons introduced in a mixture with the gas that is loaded with CO₂ in a boiler-type unit that carries out the combustion of the hydrocarbons that are introduced as a fuel by thereby consuming the minor portion of O₂ that is contained in the gas that is loaded with CO₂. This stage of elimination can intervene either directly in the gas that is obtained from the combustion process that we call crude gas or after preliminary elimination of the nitrogen in a cryogenic distillation unit. The necessity of eliminating O₂ before the re-injection in the well first corresponds to a safety concern because it is necessary to prevent any risk of O₂ accumulating in the gas that is loaded with CO₂. It is actually well known that under certain limits, said explosivity limit, the presence of O₂ in an atmosphere that is loaded with hydrocarbons presents serious dangers of explosion and should therefore absolutely be avoided in an assisted recovery process. A second reason for eliminating the O₂ that is contained in the gas that is loaded with CO₂ refers to the phase for washing with solvent which, according to a variant of the invention, can be used to separate the CO₂ from the nitrogen before its re-injection into the well; some solvents such as the amines or the methanol can actually be degraded in the presence of O₂ when the temperature levels reach values on the order of 50° and beyond.

More specifically, the invention relates to a process for eliminating oxygen from a gas that contains carbon dioxide CO₂, in which a combustion of the gas is carried out with a hydrocarbon stream in at least one catalytic combustion zone (5); combustion effluents (line 9) that essentially no longer contain O2, a major portion of CO2 and water are recovered at the end of the combustion zone; said combustion effluents are cooled in at least one heat-exchange zone (10) (4) (11) (12), and the effluents that are cooled in at least one condensation zone (13) from where condensed water (line 14) and a gaseous effluent (line 15) essentially no longer containing oxygen are extracted are condensed.

According to a characteristic of the process, the gas can contain molecular nitrogen, and it is possible to carry out a stage for separating the molecular nitrogen before the catalytic combustion stage.

According to another characteristic, the gas can contain molecular nitrogen, and it is possible to carry out a stage for separating the molecular nitrogen after the condensation stage.

According to another characteristic of the invention, it is possible to introduce into a petroleum well the effluent that is obtained from the condensation stage or the effluent that is obtained from the stage for separating the molecular nitrogen.

The O₂ content of the gas that is loaded with CO₂ can be in the range of 0.1 to 30% by weight and preferably in the range of 0.5 to 20% by weight.

According to another characteristic, the gas that is loaded with CO₂ can be preheated before entering the combustion zone at a temperature of between 100 and 600° C. and preferably at a temperature of between 300 and 550° C.

According to another characteristic, the gas that is loaded with CO₂ can contain hydrogen sulfide (H₂S) that is recovered in the sulfur dioxide (SO₂) state with the condensation water that is obtained from the condensation zone.

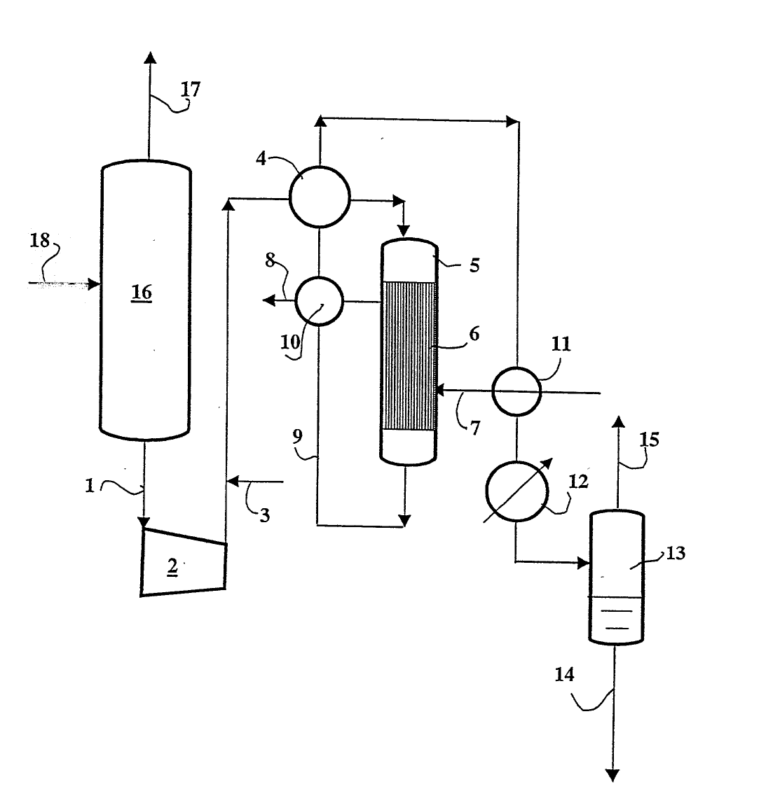

The invention will be better understood with reference to FIG. 1 that is attached and that corresponds to a diagram of the process of purification in which the stage for separating the nitrogen from the CO₂ stream that is introduced via line 18 is carried out upstream from the stage for eliminating the O₂ by means of a cryogenic distillation unit (16). In this case, the initial separation of nitrogen (line 17) from the gaseous stream that is loaded with CO₂ offers the advantage of reducing the volumetric flow rate of the gas that is to be treated in the purification stage and therefore of reducing the size of the purification unit and associated equipment. It requires, however, separating in advance the water that is contained in the gas to be treated in a separation stage, advantageously in a molecular sieve, not shown in FIG. 1. In addition, the gas that is to be treated and from which its water is removed can contain up to 90% nitrogen and typically on the order of 2 to 5% O₂. Under these conditions, it is very difficult to carry out a separation of the nitrogen and the CO₂ such that the CO₂ contains virtually no more O₂, because O₂ has the tendency to be preferably recovered at the top of the distillation column; it would then be necessary to assume an important loss of CO₂ at the top of the column and therefore a lowering of the yield of CO₂. With the purification unit that is the object of this invention, placed downstream from the cryogenic distillation, it is possible to use this CO₂ yield loss by assuming that a significant portion of the O₂ that is contained in the gas to be treated exits mixed with CO₂ at the bottom of the cryogenic distillation column. It is even possible to admit into the stream that exits from the bottom of the cryogenic distillation column a certain amount of nitrogen if the latter allows a more economical operation of said column. The flow that is loaded with CO₂ and that is introduced via line (1), dry and containing a minor portion of O₂, exiting the cryogenic distillation column, is then evaporated at a pressure that is slightly superior to the atmospheric pressure, then it is compressed at a pressure of 2 to 30 bar, preferably 2 to 10 bar and typically to about 7 bar (1 bar 10⁵ Pa) in a compressor (2) so as to reduce the size of the downstream equipment and to relieve the final recompression of the CO₂ after purification in the purification unit that is the object of this invention, without its re-injection into the well. At a suitable pressure level, an approximately stoichiometric amount of fuel that is introduced via line (3), whereby the stoichiometric term is understood relative to the O₂ content of the gas to be treated, is added to this gas. The added fuel may be gaseous, without this being any limitation. This fuel will be selected in the range of fuels that are available on the site. It will contain for the most part hydrocarbons that have a number of carbon atoms of between 1 and 30 and preferably 1 to 10, i.e., it can be a mixture of hydrocarbon fractions that range from methane to heavy residue. More specifically, the fuel flow rate that is introduced in a mixture with the gas that is loaded with CO₂ will be selected so as to produce essentially anaerobic combustion conditions. If the flow rate of fuel available on the site is, for example, much higher than the value corresponding essentially to the stoichiometric conditions, however, it will always be possible to add a supply of air so as to be under essentially anaerobic combustion conditions. The CO₂ that results from the combustion of the hydrocarbon portion that is introduced in excess relative to the stoichiometric conditions of the gas to be treated will be found in addition to the CO₂ initially contained in the gas to be treated, which will not be a problem in the subsequent application of this total CO₂ stream that is intended to be re-injected in a production well. The CO₂/fuel mixture is preheated indirectly in an exchanger (4) at a temperature of 100 to 600° C. and preferably between 300 and 550° C. from the heat that is contained in the combustion gases that are obtained from the purification stage. The O₂ purification stage will preferably be carried out ink with catalytic combustion (5) of the gas that is loaded with CO₂ after addition of the suitable amount of hydrocarbon fuels (line 3). Catalytic combustion stage (5) can be carried out in all boiler types that allow a use of the catalyst that is well known to one skilled in the art. The catalyst is selected from among those that are well known to one skilled in the art, in the form of balls or extrudates that contain a noble metal of the platinum family. The catalyst will be used in general in the fixed-bed state inside a large number of tubes inside of which will circulate the gas to be treated/fuel mixture. The catalyst can also be used in the form of a deposition in the walls of a multitude of channels such as those that are formed by the honeycomb-type cordierite structure, for example, that is found, for example in the catalytic converters for automobiles. The monitoring of the temperature is an important aspect in the catalytic combustion for the protection of the catalyst, and the latter can be carried out with a coolant that will generally be medium- or high-presser water vapor but that can also, as appropriate, be overheated vapor. An effluent that is obtained from the catalytic combustion stage via line (9) therefore contains a majority of CO₂, water vapor that is obtained from the combustion, optionally a certain amount of nitrogen and essentially no longer contains O₂. The effluent of the catalytic combustion stage (line 9) is then cooled in at least one exchanger (10), (4), (11), (12) with coolants that are introduced via lines (7) and (8).

In general, the fluid that is introduced via line (7) will be the cooling water of the catalytic combustion zone, and the fluid that is exiting said catalytic combustion zone via line (8) will be the vapor that is generated by the combustion heat.

After cooling in exchanger (12), the catalytic combustion effluent (line 9) is introduced into a condensation flask (13), at the bottom of which condensation water is recovered via line (14) and at the top of which a gas that contains a majority of CO2 and essentially more O2 is recovered via line (15). This gas can then be recompressed at a suitable pressure level before being re-injected via an injector well into reservoir rock to carry out assisted recovery of petroleum.

In another variant of the invention that is not shown, the gas that is to be treated, therefore containing a significant amount of nitrogen, is sent directly into the O₂ purification unit. In the same way as in the variant described above, the O₂ purification stage consists of a catalytic combustion at the end of which are recovered an effluent that contains a major portion of CO₂, nitrogen, and a certain amount of water that is obtained from the combustion stage itself. The effluent is then sent into the C₂ solvent recovery unit that is not the object of this invention but that can be of any type that is known to one skilled in the art. For example, this CO₂ solvent recovery unit can be the one that corresponds to the IFPEXOL process that is described in Patent U.S. Pat. No. 4,979,966 in which the solvent that is used is methanol. In a variant, this C₂ solvent recovery unit can be used as a solvent of amines, without this being any limitation of this invention.

### ILLUSTRATIVE EXAMPLE

The invention will be better understood by the following example in which it is desired to treat 1.88 million cubic meters per day of gas that is obtained from an upstream process, representing a molar flow rate of 3690 kmol/hour, or 110 tons/hour. The gas that is to be treated has the following molar composition:

| | |
|---|---|
| Nitrogen: | 88% |
| Oxygen: | 2.0% |
| CO2: | 10% |
| H2O: | none |
| HC: | none |
| Total: | 100% |

Water was removed in advance from the gas that is to be treated by passage into a recovery unit that contains a molecular sieve. This gas is available at a temperature of 40° C. and a pressure that is slightly higher than the atmospheric pressure. This gas is introduced into a cryogenic distillation unit so as to recover at the top of the column 9 kmol/hour (or 10³ mol/hour; later, the flow rates will be given in kilomol per hour), of nitrogen or 98% of the nitrogen that is contained in the feedstock of the column of the feedstock. The O₂ that is introduced into the column is preferably found at the top with the nitrogen, but about 10% of this oxygen is found in the bottom of the column with the CO₂. The liquid that exits from the bottom of the cryogenic distillation column has the following composition:

| | |
|---|---|
| Oxygen: | 7.4 kmol/hour |
| CO2: | 360 kmol/hour |
| Nitrogen: | 2.6 kmol/hour |
| Total: | 370 kmol/hour |

This bottom liquid (1) is evaporated, compressed to about 10 bar, and then mixed with 3.7 kmol/hour of methane (3). The resulting gas mixture is preheated in exchanger (4) up to a temperature of 550° C., and then it is sent into catalytic combustion zone (5), which operates at 7 bar.

Catalytic combustion zone (5) consists of a 1.3 m³ catalyst bed that corresponds to 690 kg of catalyst. In our example, the catalyst consists of spherical balls or cylindrical extrudates that are impregnated with a platinum-type noble metal. The rise in temperature due to the exothermicity of the combustion is controlled and limited to a maximum value of 50° C. by the generation of 1.10 t/h of water vapor that is saturated at 40 bar at a temperature of 250° C. and a suitable preheating for cooling (7). The hot combustion gases at 600° C. (9) are cooled in a first exchanger (10) to a temperature of 575° C. by generation of vapor that is overheated to 350° C., which corresponds to an exchanged heat amount of 0.07 Gcal/h (or 0.07 10⁹ calories/hour with the equivalence of 1 calorie, equal to 4.18 Joules). The combustion gases are then cooled in a second exchanger (4) to a temperature of 175° C. by heat exchange with the gas to be treated that is thus preheated to a temperature of 550° C. This heat exchange corresponds to an amount of heat of 1.25 Gcal/hour. The combustion gases are then cooled in a third exchanger (11) to a temperature of 150° C. by exchange with the feed water of boiler (7), which corresponds to an exchanged heat of 0.050 Gcal/hour. The combustion gases are finally cooled in a fourth exchanger (12) to a temperature of 40° C. by exchange with air or cooling water which corresponds to an exchanged heat amount of 0.63 Gcal/hour. The material balance (kmol/hour) of the entire process according to FIG. 1 is provided in the table below:

| | Lines | | | | | | |
|---|---|---|---|---|---|---|---|
| | 18 | | Denitrided | | | | |
| | Gas to be | | gas that is | | | | 15 |
| | treated | 17 | to be | 3 | 9 | 14 | CO₂ |
| | with nitrogen | N₂ | treated | Fuel | Effluent | Water | that is produced |
| N₂ | 3,247 | 3,244.4 | 2.6 | | 2.6 | | 2.6 |
| O₂ | 74 | 66.6 | 7.4 | | | | |
| CO₂ | 369 | 9.0 | 360 | | 363.7 | | 363.7 |
| H₂O | | | | | 3.7 | 3.7 | |
| CH₄ | | | | 4.0 | 0.3 | | 0.3 |
| Total | 3,690 | 3,320 | 370 | 4.0 | 370.3 | 3.7 | 370.3 |

This example shows that it is therefore possible to recover from a combustion fame-type gas a gas that essentially contains CO₂ and very little nitrogen and that essentially no longer contains oxygen, whereby this gas is ready to be re-injected after a suitable recompression in a production well for carrying out assisted recovery of petroleum.

This example also shows that the CO₂ recovery rate, which is calculated as the amount of CO₂ in the gas after purification relative to the amount of CO₂ in the gas to be treated, can reach values of upwards of 98% (363.7/369=98.6% in the example that is presented).

This example also shows that the total amount of heat exchanged at exchangers (10), (4), (11) and (12) is 2 Gcal/hour (1 cal=4.18 Joules) and that about 70% of this heat is provided by the recovery of calories that are provided by effluents (9) of the catalytic combustion zone. The process is therefore economical and virtually balanced in terms of heat exchange.

1.Process for essentially total elimination of oxygen from a gas that contains carbon dioxide, whereby the process is characterized in that:
a) Combustion of the gas is carried out with a hydrocarbon stream in at least one catalytic combustion zone (5),
b) At the end of the combustion zone, combustion effluents (line 9) that essentially no longer contain O₂, a major portion of CO₂, and water are recovered,
c) Said combustion effluents are cooled in at least one thermal exchange zone (10) (4) (11) (12),
d) The effluents that are cooled are condensed in at least one condensation zone (13), and condensed water (line 14) and a gaseous effluent (line 15) essentially no longer containing oxygen are recovered.

2. Process according to claim 1, wherein the gas contains the molecular nitrogen and wherein a stage for separating the molecular nitrogen is carried out before the catalytic combustion stage.

3. Process according to claim 1, wherein the gas contains the molecular nitrogen and wherein a stage for separating the molecular nitrogen is carried out after the condensation stage.

4. Process according to one of claims 1 to 3, wherein the effluent that is obtained from the condensation stage is introduced into a petroleum well for carrying out an assisted recovery of petroleum.

5. Process according to one of claims 2 and 3, wherein the effluent that is obtained from the stage for separating the molecular nitrogen is introduced into a well for carrying out assisted recovery of petroleum.

6. Process according to one of claims 1 to 5, wherein the O₂ content of the gas that is loaded with CO₂ is in the range of 0.1 to 30% by weight and preferably in the range of 0.5 to 20% by weight.

7. Process according to one of claims 1 to 6, wherein the hydrocarbon stream that is introduced in a mixture with the gas to be treated in the combustion zone comprises 1 to 30 carbon atoms and preferably 1 to 10 carbon atoms.

8. Process according to one of claims 1 to 7, wherein the gas that is loaded with CO₂ is preheated before entering the combustion zone to a temperature of between 100 and 600° C. and preferably to a temperature of between 300 and 550° C.

9. Process according to one of claims 1 to 8, wherein the catalyst that is used in the combustion zone is a catalyst in the form of balls or extrudates that contains a noble metal of the platinum family.

10. Process according to any of claims 1 to 9, wherein the gas that is loaded with CO₂ is compressed before its input into the combustion zone at a pressure level of between 2 and 30 bar and preferably between 2 and 10 bar.

11. Process according to one of claims 1 to 10, wherein the gas that is loaded with CO₂ contains hydrogen sulfide (H₂S) that is recovered in the sulfur dioxide (SO₂) state with condensation water that is obtained from the condensation zone.

12. Process according to one of claims 1 to 11, wherein the stage for preheating the gas that is loaded with CO₂ is carried out by means of an indirect heat exchange with the effluents of the combustion zone.

13. Process according to one of claims 1 to 2 and 4 to 11, wherein the stage for separating the nitrogen from the gaseous effluent before the catalytic combustion stage is carried out by cryogenic distillation.

14. Process according to one of claims 1 to 13, wherein the catalyst is deposited on a honeycomb-type cordierite substrate, whereby the mixture of gas that is loaded with CO₂ and a hydrocarbon stream that is used for combustion flows inside multiple channels of the substrate.

15. Process according to one of claims 1 to 2 and 4 to 14, wherein the gas contains water vapor and wherein a stage for eliminating water is carried out before the stage for separating the molecular nitrogen.
